(19) United States
(12) Patent Application Publication
(10) Pub. No.: US 2008/0079820 A1
(43) Pub. Date: Apr. 3, 2008

(54) Image Capture and Display Arrangement

(76) Inventor: Leslie James McSpadden, New South Wales (AU)

Correspondence Address: LADAS & PARRY, 26 WEST 61ST STREET, NEW YORK, NY, 10023, US

(21) Appl. No.: 11/792,909

(22) PCT Filed: Dec. 16, 2005
(86) PCT No.: PCT/AU05/01903

§ 371 Date: Aug. 30, 2007

(30) Foreign Application Priority Data
Dec. 17, 2004 (AU) 2004907190

(51) Int. Cl. H04N 5/76

(52) U.S. Cl. 348/231.99; 348/E05.024

(57) ABSTRACT

An electronically delayed mirror apparatus (200) is disclosed. The apparatus (200) is adapted for capturing a visual recording of a person, and displaying said recording in a manner offset in time from said capturing. The apparatus comprises an image detector (202), a storage device (303) for storing the visual recording, a display (203) for displaying the visual recording, wherein the display (203) and the image detector (202) are both directed towards the subject to be visually recorded, and a time delay device (307) for establishing the time offset.

### CROSS-REFERENCE TO RELATED PATENT APPLICATIONS

This application claims the right of priority from Australian Provisional Patent Application No. 2004907190, filed 17 Dec. 2004, which is incorporated by reference herein in its entirety as if fully set forth herein.

### FIELD OF THE INVENTION

The present invention relates generally to image capture and display arrangements and, in particular, to capture and display of images for short timeframe applications.

### BACKGROUND

Since time immemorial, men and women have used mirrors (also referred to as cosmetic mirrors) in order to check their appearance. Traditional mirrors are limited in that, for example, a single mirror does not allow the user to see the back of their head, and for this purpose, an arrangement of three hinged mirrors is used. This type of arrangement is, however, limited to fixed configurations such as those found on a dressing table.

### SUMMARY

It is an object of the present invention to substantially overcome, or at least ameliorate, one or more disadvantages of existing arrangements.

Disclosed are arrangements, referred to as electronically delayed mirrors, which seek to address the above problems by capturing an image using a digital capture device, and displaying it with a programmable time delay, on a screen that is mounted in a substantially coplanar fashion with the digital capture device, wherein both the display and the digital capture device are simultaneously directed towards the subject whose image is to be captured.

According to a first aspect of the present invention, there is provided an electronically delayed mirror apparatus for capturing and displaying at least one image of a subject in a delayed manner, the apparatus comprising:

an image detector;

a storage device for storing the at least one captured image;

a display for displaying the at least one captured image, wherein the display and the image detector are directed towards the subject of which the at least one image is to be captured; and

a time delay device for displaying the at least one captured image a specified time after the at least one image is captured.

According to another aspect of the present invention, there is provided an electronically delayed mirror apparatus for capturing a visual recording of a person, and displaying said recording in a manner offset in time from said capturing, the apparatus comprising:

an image detector;

a storage device for storing the visual recording;

a display for displaying the visual recording, wherein the display and the image detector are both directed towards the subject to be visually recorded; and

a time delay device for establishing the time offset.

According to another aspect of the present invention, there is provided a system for display and sale of an item, the system comprising:

an electronically delayed mirror apparatus for capturing a visual recording of a person, and displaying said recording in a manner offset in time from said capturing, the apparatus comprising:
an image detector;
a storage device for storing the visual recording;
a display for displaying the visual recording, wherein the display and the image detector are both directed towards the subject to be visually recorded;
a time delay device for establishing the time offset;
a user interface enabling a user to provide information associated with the item to be purchased, said item forming an element in the visual recording; and
communication means for communicating the information to a processor;

the processor, being able to access a database storing stock level and pricing information for said merchandise; and

said database; wherein the system uses information provided by the user via the user interface and communicated to the processor to process information in the database in order to effect a transaction relating to said sale of said item.

According to another aspect of the present invention, there is provided a method for capturing and displaying at least one image of a subject in a delayed manner, the method comprising the steps of:

simultaneously directing an image detector and a display towards the subject of which the at least one image is to be captured;

capturing the at least one image;

storing the at least one captured image; and

displaying the at least one captured image a predetermined delay time after the at least one image is captured.

According to another aspect of the present invention, there is provided a method for capturing a visual recording of a person, and displaying said recording in a manner offset in time from said capturing, the method comprising the steps of:

directing an image detector and a display towards the person to be visually recorded;

capturing the visual recording;

storing the visual recording; and

displaying said recording in a manner offset in time from said capturing.

According to another aspect of the present invention, there is provided an electronically delayed mirror apparatus for capturing a visual recording of a person, and displaying said recording in a manner offset in time from said capturing, while said capturing continues, the apparatus comprising:

a memory for storing a program; and

a processor for executing the program, said program comprising:

code for effecting the visual recording of the person captured by the image detector;

code for storing said visual recording; and

code for displaying the visual recording in a manner offset in time from said capturing, while said capturing continues.

Other aspects of the invention are also disclosed.

### BRIEF DESCRIPTION OF THE DRAWINGS

Some aspects of the prior art and one or more embodiments of the present invention will now be described with reference to the drawings and appendices, in which:

FIG. 1 shows a prior art digital camera;

FIG. 2 shows a pictorial view of a desk-mounted arrangement of the disclosed electronically delayed mirror;

FIG. 3 shows a pictorial view of a hand-held cosmetic mirror arrangement of the electronically delayed mirror;

FIG. 4 shows a functional data-flow diagram of the electronically delayed mirror;

FIG. 5 shows a schematic diagram of a special-purpose computer upon which the electronically delayed mirror can be implemented;

FIG. 6 depicts a user operating the hand-held electronically delayed mirror in one scenario;

FIG. 7 shows a user operating a wall-mounted electronically delayed mirror;

FIG. 8 shows a flowchart of a process for capturing image(s);

FIG. 9 shows a flowchart of a process for displaying captured image(s) on the electronically delayed mirror;

FIG. 10 shows a flowchart of a business process in which the electronically delayed mirror is used

FIG. 11 depicts another business process flowchart using the electronically delayed mirror; and

FIG. 12 shows how the business process of FIG. 11 can be applied to current and historic stored image(s).

### DETAILED DESCRIPTION INCLUDING BEST MODE

It is to be noted that the discussions contained in the Background section relating to prior art arrangements relate to discussions of devices that form public knowledge through their use. These discussions should not be interpreted as a representation by the present inventor, or by the patent applicant(s), that such devices in any way form part of the common general knowledge in the art.

Where reference is made in any one or more of the accompanying drawings to steps and/or features, which have the same reference numerals, those steps and/or features have for the purposes of this description the same function(s) or operation(s), unless the contrary intention appears.

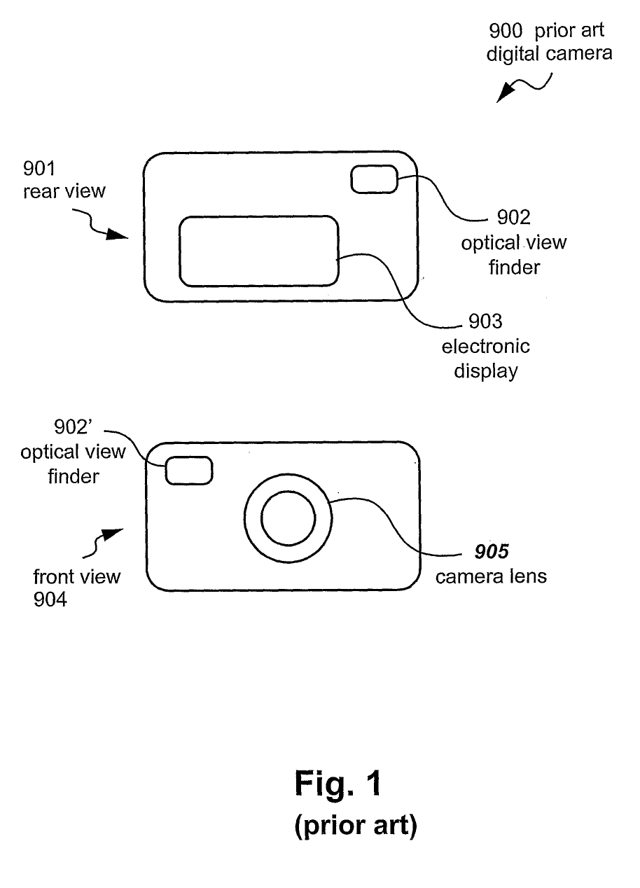

FIG. 1 shows a prior art digital camera 900. A rear view 901 of the camera shows an optical viewfinder 902 through which a user can view the image to be captured. An electronic display 903 is also shown, this having equivalent functionality to the optical viewfinder 902, meaning that the user can view the image to be captured by the camera 900 using the electronic display 903. A front view 904 of the camera 900 shows a front view 902′ of the optical viewfinder, and also shows a lens 905 through which the image is captured.

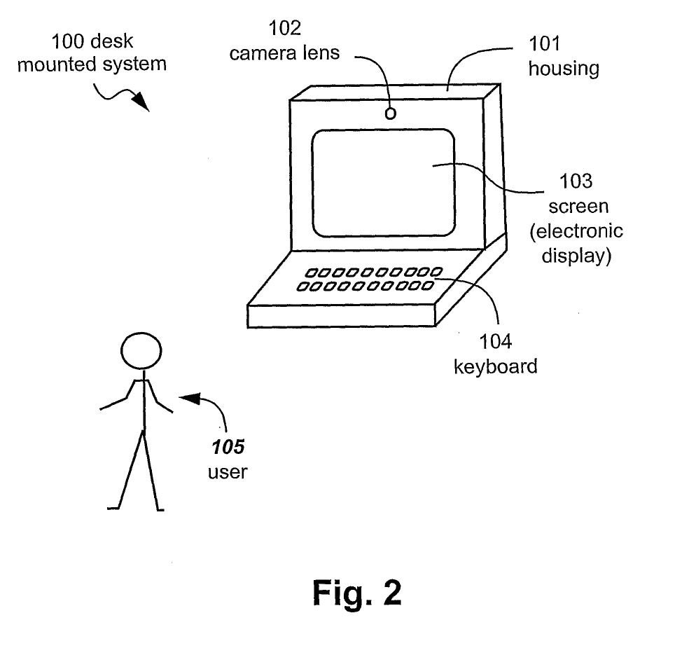

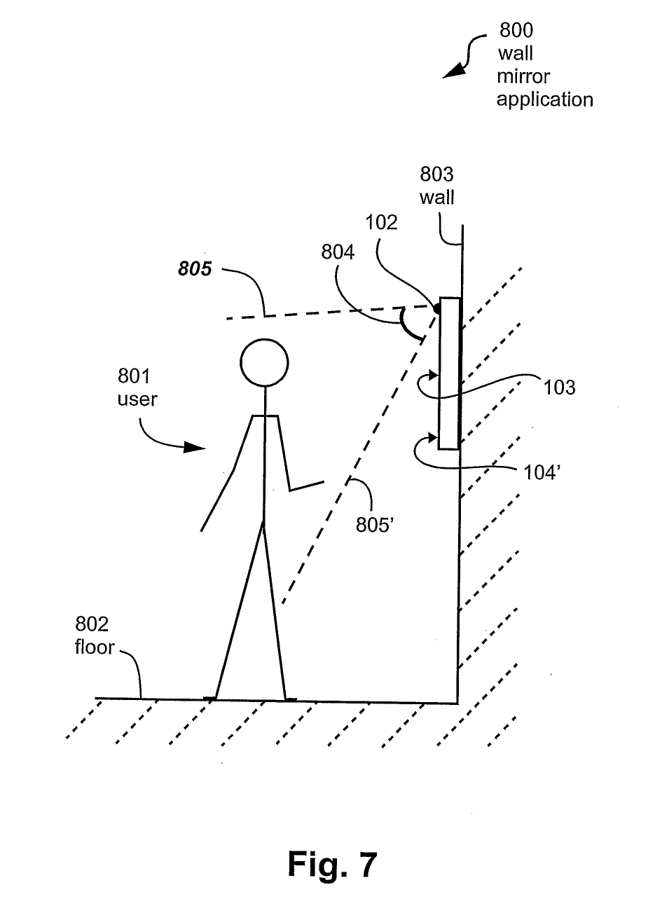

FIG. 2 shows a desk-mounted arrangement of the electronically delayed mirror. In the apparatus 100 a user 105 is located in front of the apparatus 100 that comprises a lens 102 and a display 103 mounted in a housing 101. A keyboard 104 is shown in desktop configuration. The keyboard 104 can also be configured to lie in a flat plane with the housing 101, as described in relation to the wall mounted configuration of FIG. 7. Clearly the electronically delayed mirror 100 in FIG. 2 differs fundamentally from the prior art camera 900 in FIG. 1, in that the user 105 can view a time delayed image displayed on the screen 103 at the same time as the lens 102 continues to capture the image of the user 105. The user can interact with a processing system (not shown) that is mounted in the housing 101 via the keyboard 104.

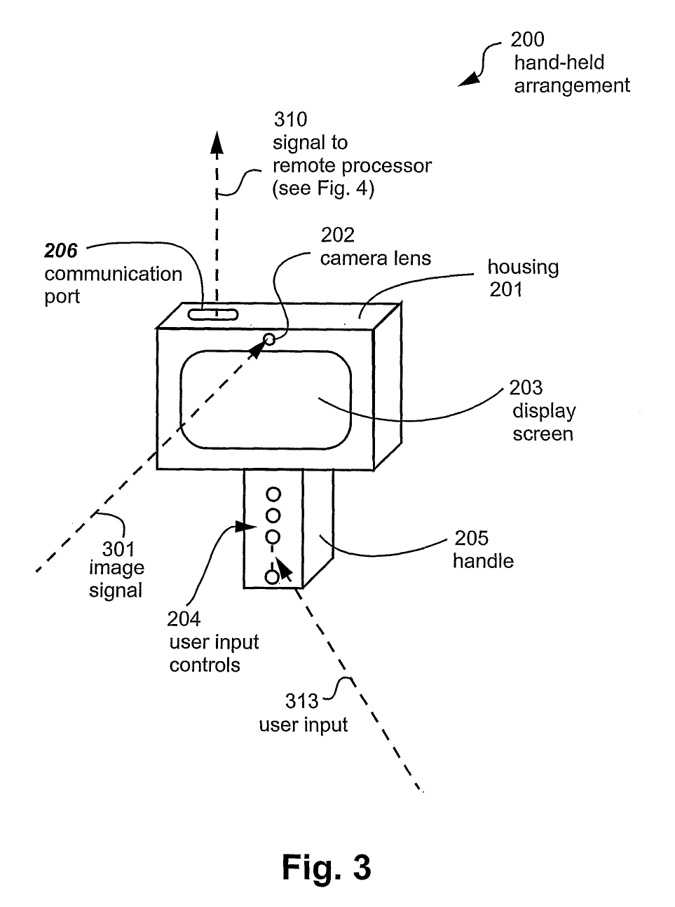

FIG. 3 shows an alternate arrangement 200 of the electronically delayed mirror. The arrangement 200 consists of a camera lens 202 and a display screen 203 mounted on a housing 201. In the hand-held arrangement, the housing 201 is mounted on a handle 205 that contains user input controls 204. Accordingly, the arrangement 200 is adapted to be used in much the same manner by the user as a hand-held mirror. In other words, the user is able to hold the handle 205 in a manner that directs both the lens 202 and the display screen 203 towards the user's face, for example. This enables an image signal 301 of the user to be captured via the lens 202, and to be presented by a processing system (not shown) that is mounted in the housing 201, this image being displayed on the display screen 203 in a time-delayed fashion for the user to view.

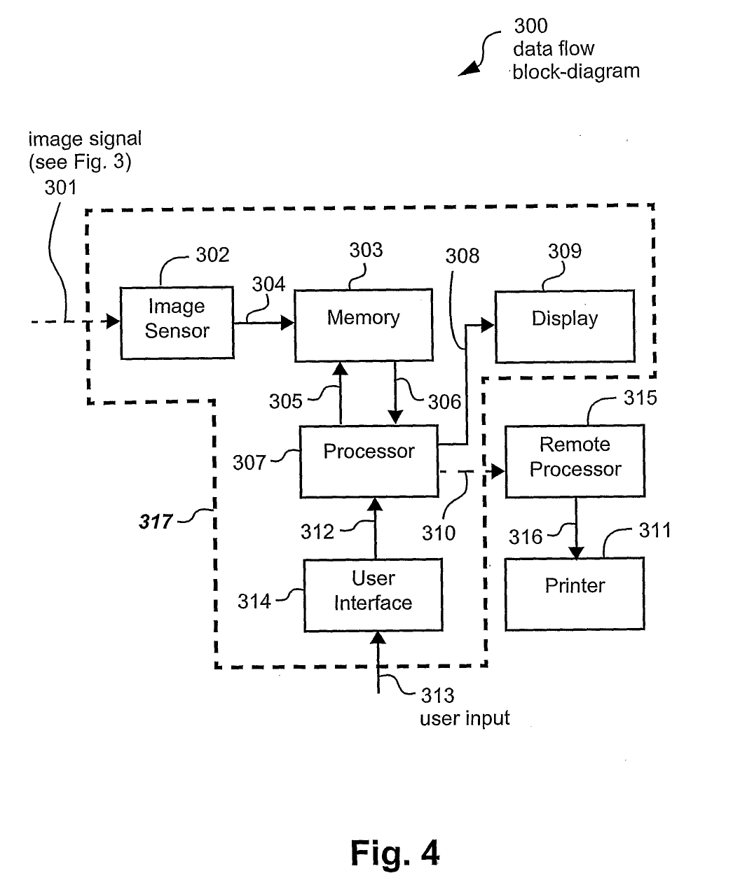

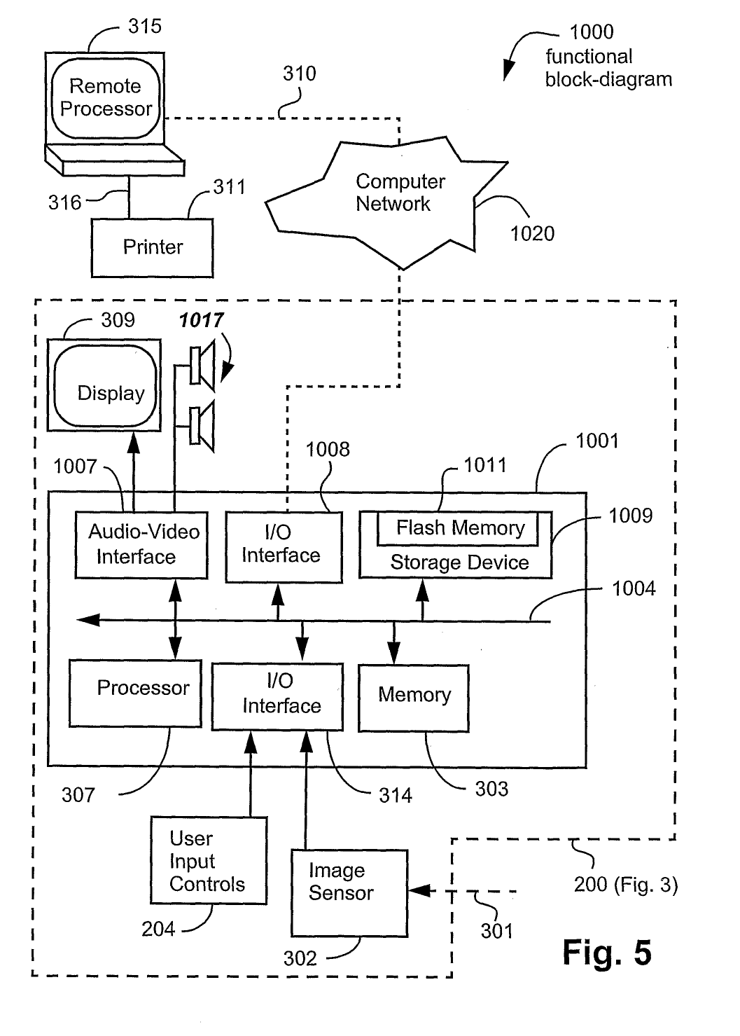

The arrangement 200 also has a communication port 206 enabling image information loaded into the hand held time delayed mirror arrangement 200, and/or commands entered via the user input controls 204, to be communicated, as depicted by a dashed arrow 310, from the hand-held system 200 to a remote processor 315 (see FIGS. 4, 5). The aforementioned commands are depicted by a dashed arrow 313 directed at the user input controls 204. This communication facility enables the user to signal their selection of a particular pair of spectacles by pressing, as depicted by the dashed arrow 313, an appropriate one of the user input controls 204, thereby enabling the remote processor 315 to (a) determine the cost of the selected pair of spectacles from a price database stored on a memory (not shown) in the remote processor 315, (b) add the aforementioned cost to the amount to be charged to the user, and (c) print out an invoice for the user on the printer 311 if the user indicates that they have completed their survey of the available pairs of spectacles. The communication port 206 also enables the user to print out an image of themselves wearing the selected pair of spectacles on a printer 311 (see FIG. 4).

The above-noted communication between the arrangement 200 and the remote processor is effected in a wireless manner, so that the user can walk around in an unencumbered manner while sending information to the remote processor. In another arrangement, the communication can be effected by the user first loading information into a memory (see 303 in FIG. 4) in the arrangement 200, and later physically connecting the arrangement 200 to the remote processor using a physical connection rather than a wireless connection.

The above-described arrangement involves the electronically delayed mirror and a remote processor. In an alternate arrangement, all functional elements can be incorporated into the electronically delayed mirror itself. In other words, the electronically delayed mirror can itself (a) determine the cost of the selected pair of spectacles from a price database stored in a memory in the electronically delayed mirror, (b) add the aforementioned cost to the amount to be charged to the user, and (c) print out an invoice for the user on the printer 311 if the user indicates that they have completed their survey of the available pairs of spectacles.

One or more of the hand held arrangements 200 can be removably mounted on a fixed or movable rack in a store in which the electronically delayed mirrors are to be used. Advertising associated with the store can be displayed on the display screens 203 of the electronically delayed mirrors when they are not in use, this providing an added benefit to the store owner. The advertising can be terminated as soon as an electronically delayed mirror is taken from the rack, or as soon as a user operates one of the user controls 204. The aforementioned advertising information can be loaded into the memory 303 via the communication port 206. The aforementioned mounting rack can be fitted with charging modules so that the electronically delayed mirrors charge their internal batteries when on the rack and not in use. Alternately, the electronically delayed mirrors can be attached to other wall mounted charger modules.

The electronically mounted mirrors can be fitted with electronic tags to prevent the mirrors from being removed from the store in an unauthorised manner. The electronically delayed mirrors can be sold or leased to the store.

Clearly the aforementioned advertising function can be applied to any of the various arrangements of the electronically delayed mirror. In regard to powering arrangements, the desk and wall mounted arrangements can be powered directly by mains power, while the hand held arrangement would typically be powered by a rechargeable battery module.

FIG. 4 shows a functional data flow diagram 300 of the hand-held electronically delayed mirror depicted in FIG. 3. The image signal 301 is captured by an image sensor 302 that outputs a corresponding captured image signal 304 to a memory 303. The captured image signal 304 is written into the memory 303 under control of a signal 305 from a processor 307. The processor 307 reads data from the memory 303 using a read signal 306. The processor 307 can display contents of the memory 303 on a display 309 via a connection 308. The processor 307 can alternately send the contents of the memory 303 to the remote processor 315, via a connection 310 established between the communication port 206 on the hand-held arrangement 200 and a corresponding communication port (not shown) on the remote processor, thereby enabling the remote processor 315 to output a stored image on the printer 311. The operation of the processor 307 is directed by control signals 312 that are generated by a user interface 314 as a result of receiving user inputs 313 from the user (not shown).

The desk-mounted arrangement of FIG. 2 operates in a generally similar manner to that depicted in FIG. 4 for the hand-held arrangement, apart from the fact that the desk-mounted arrangement does not require the remote processor 315, and the processor in the desk-mounted arrangement communicates directly with the printer 311.

FIG. 5 shows a functional block diagram of special-purpose computer arrangement 1000 upon which the hand-held electronically delayed mirror 200 in FIG. 3 can be implemented. FIG. 5 is generally applicable to the desk-top arrangement of FIG. 2, except that the desk-top arrangement does not require the remote processor 315 and the desk-top arrangement 100 can communicate directly with the printer 311.

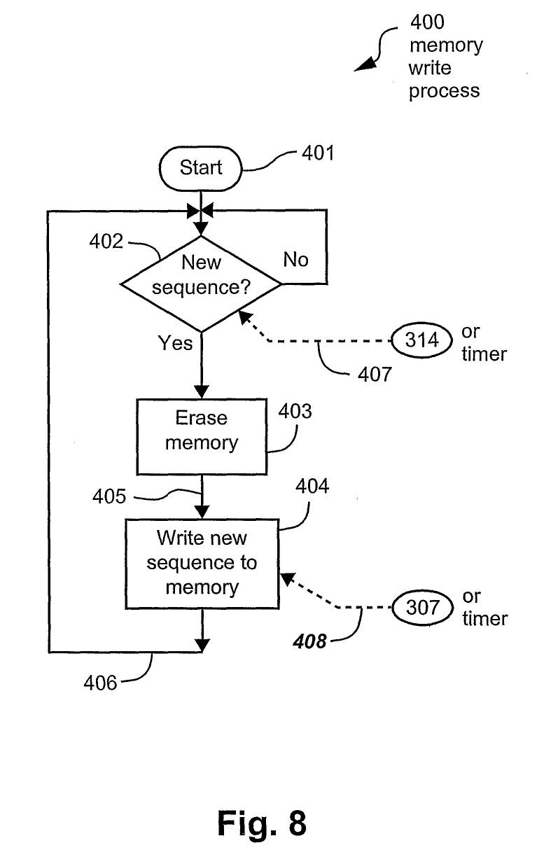

The processes of FIGS. 8-12 may be implemented as software, such as an electronically delayed mirror application program executing within the computer system 1000. In particular, the method steps used by the electronically delayed mirror are effected by instructions in the software that are carried out by the computer arrangement 1000. The instructions may be formed as one or more code modules, each for performing one or more particular tasks.

The software may also be divided into two separate parts, in which a first part performs the electronically delayed mirror methods and a second part manages a user interface between the first part and the user. Thus, for example, although the user input controls 204 in FIG. 3 are depicted as control buttons on the handle 205, a Graphical User Interface (GUI) can be displayed on the display 203, and if this display 203 is implemented using a touch sensitive screen. In such an arrangement the user interface can be operated by the user touching appropriate soft controls on the GUI so displayed on the screen 203. A similar arrangement can also be used in the desk-top arrangement in FIG. 2.

The software may be stored in a computer readable medium, including the storage devices described below, for example. The software is loaded into the computer arrangement 1000 from the computer readable medium, and then executed by the computer. A computer readable medium having such software or computer program recorded on it is a computer program product. The use of the computer program product in the computer preferably effects an advantageous apparatus for practicing the electronically delayed mirror.

The computer system 1000 is formed by a computer module 1001, input devices such as the image sensor 302 and the user controls 204, output devices including the printer 311 and the display device 309 and audio speakers 1017 that can provide the user with audio feedback to indicate, for example, that user controls have been activated. The computer module 1001 typically includes at least the one processor unit 307, and the memory unit 303, for example formed from semiconductor random access memory (RAM) and read only memory (ROM). The module 1001 also includes a number of input/output (I/O) interfaces including a graphic interface 1007 that couples to the image display 309, the I/O interface 314 for the user input controls 204 and the image sensor 302, and an interface 1008 for communication to the remote processor 315. The communication between the electronically delayed mirror 200 and the remote processor 315 is depicted by the dashed line 310. A computer network 1020 is also shown to indicate that the aforementioned communication can be effected over any suitable communication network.

A storage device 1009 is provided and can include, among other modules such as a floppy drive and/or a CD drive (not shown) a flash memory 1011. The components 1007, 1008, 1011, 307, 314 and 303 of the computer module 1001, typically communicate via an interconnected bus 1004 and in a manner that results in a conventional mode of operation of the computer module 1001 known to those in the relevant art. Examples of computers on which the described arrangements can be practised include IBM-PC's and compatibles, Sun Sparcstations or alike computer systems evolved therefrom.

Typically, the electronic mirror software application program is resident on the flash memory 1011 and read and controlled in its execution by the processor 307. Intermediate storage of the program may be accomplished using the semiconductor memory 303. The software can be loaded into the computer system 1000 from any suitable computer readable media. The term “computer readable medium” as used herein refers to any storage or transmission medium that participates in providing instructions and/or data to the computer system 1000 for execution and/or processing.

Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 1001. Examples of transmission media include radio or infra-red transmission channels as well as a network connection to another computer or networked device, and the Internet or Intranets including e-mail transmissions and information recorded on Websites and the like.

The method used by the electronically delayed mirror may alternatively be implemented in dedicated hardware such as one or more integrated circuits performing the functions or sub functions of the electronically delayed mirror. Such dedicated hardware may include graphic processors, digital signal processors, or one or more microprocessors and associated memories.

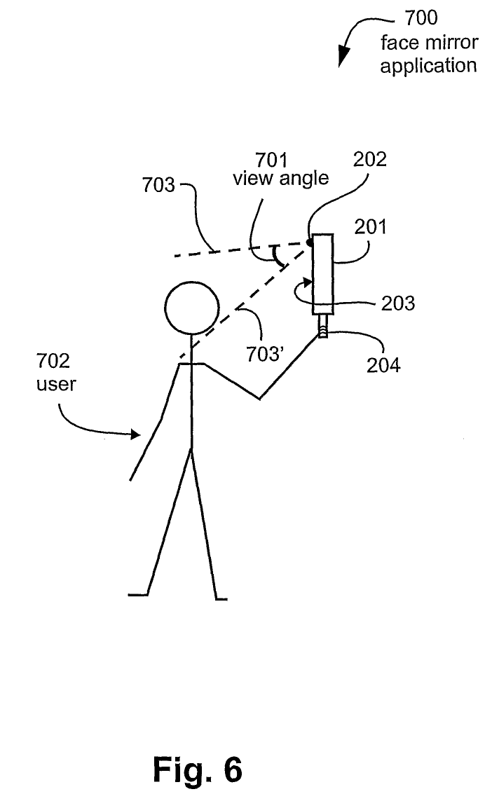

FIG. 6 depicts a user 702 operating the hand-held electronically delayed mirror 200 in one scenario 700. The user 702 holds the handle 204 in a manner that directs the camera lens 202 and the display screen 203 towards the face of the user 702. The camera lens 202 has a viewing angle 701 that encompasses the face of the user 702 as depicted by dashed lines 703 and 703′. When the electronically delayed mirror 200 is activated by the user 702, then the image(s) captured by the lens 202 is loaded into the memory 303 of the hand-held arrangement. In one operating mode the display 203 can show the current view of the user 702′ that is being captured by the lens 202. That view can also be simultaneously recorded and stored in the memory 303 for later play back, when another appropriate operating mode is selected by the user.

FIG. 7 shows a different arrangement to that shown in FIG. 6, wherein the electronically delayed mirror 100 of FIG. 2 is mounted on a wall 803. A user 801 stands in front of the lens 102 and the screen 103 of the electronically delayed mirror 100 and operates the electronically delayed mirror 100 via a keyboard interface 104′. The camera lens 102 has a viewing angle 804 that encompasses the head and upper body of the user 801 as depicted by dashed lines 805 and 805′. When the electronically delayed mirror 100 is activated by the user 801, then the image(s) captured by the lens 102 is loaded into the memory 303 of the desk-mounted arrangement.

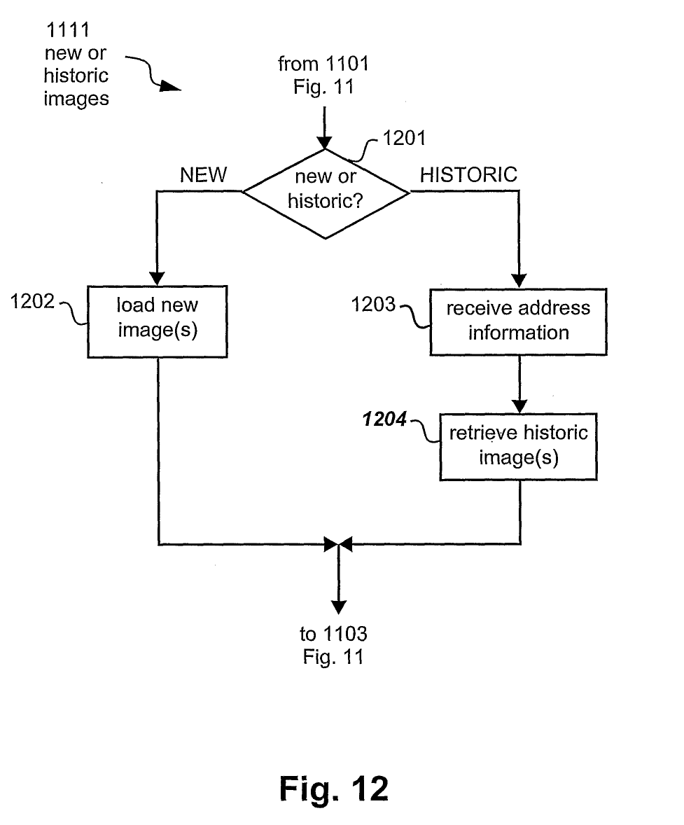

FIG. 8 shows a flowchart for a process 400 that writes the captures image(s) signal 304 into the memory 303 (see FIG. 4). The process 400 commences with a START step 401, after which a decision step 402 determines if a new image, or a new sequence of images (such as a video clip) is to be recorded. If this is not the case, then the process 400 follows a NO arrow, in a looping fashion, back to the step 402. If, on the other hand, a new recording is desired, then the process 400 follows a YES to a step 403 that erases the contents of the memory 303, after which a step 404 writes new image(s) via 304 to the memory 303 (see FIG. 4). Thereafter, the process 400 follows an arrow 406 back to the step 402. In another arrangement, the images previously loaded into the memory 303 are not erased, but instead are maintained for later access such as is described, for example, in relation to a step 1204 in the process of FIG. 12.

From an operational perspective, the testing step 402 is activated by the user input 313 as processed by the user interface 314, this being depicted by a dashed line 407. In contrast, the step 404 is activated by the processor 307 as depicted by a dashed line 408. The activation signals 407 and 408 can also be provided by a timer (not shown).

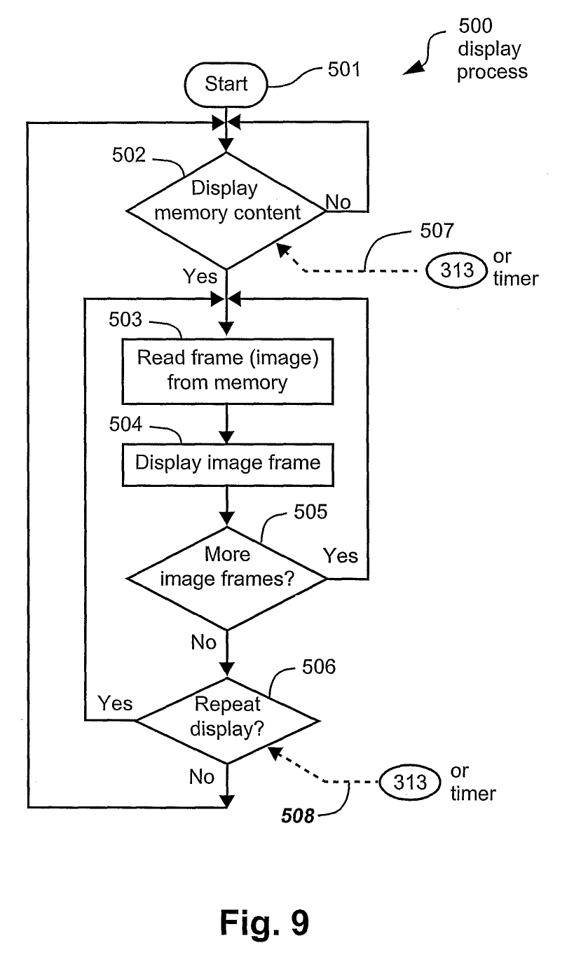

FIG. 9 shows a flowchart for a process 500 that provides a display of still images, or video clips, previously stored in the memory 303 on the display 309 or alternately that outputs the aforementioned still images or video clips on a printer 311 (see FIG. 4). Video clips are typically not printed in their entirety, but instead representative key frames (identified by appropriate metadata associated with the video clips) or sampled frames (eg every 10^{th} frame or 100^{th} frame) is output to the printer.

The process 500 commences with a START step 501 after which a testing step 502 determines if the contents of the memory 303 are to be displayed. This step can be activated via a user input 313 (see FIG. 4) or by a timer (not shown).

If the step 502 returns a logical TRUE value, then the process 500 is directed by a YES arrow to a step 503 that reads an image, or a video clip if the visual information being considered consists of a video clip, from the memory 303. Thereafter, a step 504 displays the aforementioned image or the video clip on the display 309. A subsequent testing step 505 determines if there are further images or video clips in the memory 303. If this is not the case, the process 500 follows a NO arrow to a testing step 506 that determines if the aforementioned display process is to be repeated. The step 506 is activated by the user input 313 (see FIG. 4) or alternately by a timer (not shown). If the step 506 returns a logical FALSE value, then the process 500 follows a NO arrow back to the step 502. Returning to the step 505, if the step returns a logical TRUE value, then the process 500 follows a YES arrow back to the step 503. Returning to the step 506, if a step returns a LOGICAL true value, then the process 500 follows a YES arrow back to the step 503.

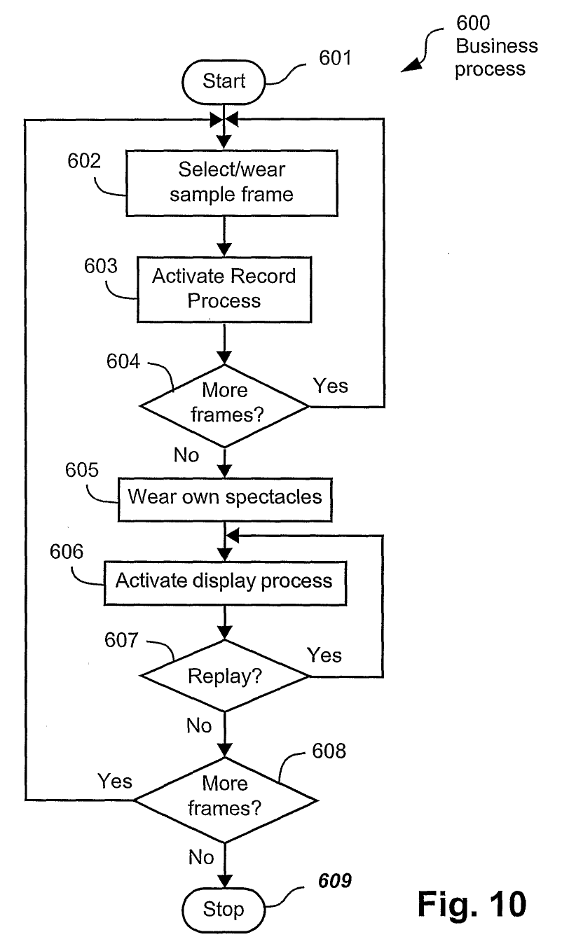

FIG. 10 shows a flowchart of a business process 600 in which the electronically delayed mirror is used in a business context. In particular, the business context relates to a user who wishes to buy a set of new spectacle frames at an optometrist. The problem previously faced by such a user was that in order to try on a new pair of spectacle frames, the user had to remove their own spectacles. This meant that the user, who typically required his or her own “prescription” spectacles in order to see clearly, had to view the new spectacle frames without the benefit of their normal spectacles. This meant that the user had to choose spectacle frames based either on the opinion of other people in the shop, or alternately, the user had to choose spectacle frames based on their own imperfect vision in the absence of their own spectacles.

The process 600 uses the electronically delayed mirror disclosed in the specification to overcome, or at least ameliorate, the problems that the aforementioned user typically faced. The process 600 commences with a START step 601 after which in a step 602 the user removes their own spectacles, and selects and wears a sample set of spectacle frames in which the user is interested. The user then either stands in front of the wall-mounted electronically delayed mirror 800 of FIG. 7, or alternately holds the hand-held electronically delayed mirror 200 of FIG. 3, and, according to the step 603, activates the memory write process 400 via a suitable user input 313. This loads the image, or set of images, or video clip, in this example of the user wearing the sample set of spectacle frames, into the electronically delayed mirror.

In a following step 604 the user decides whether they wish to try on one or more other sample spectacle frames. If this is not the case, then the process 600 follows a NO arrow to a step 605 in which the user removes the sample spectacle frames, and again puts on their own spectacles. Thereafter, in a step 606, the user activates the display process 500 via an appropriate user input 313 (see FIG. 4). The effect of this process is to display on the screen 103 or the screen 203, depending upon which configuration of the electronically delayed mirror the user has elected to use, previously loaded views of the user in the various spectacle frames which the user has tried and recorded using the electronically delayed mirror. This enables the user to clearly see which of the new spectacle frames are the most flattering, and to make a self-informed commercial and personal decision that would have been impossible without using the disclosed electronically delayed mirror.

In a following testing step 607 the user decides whether to replay the display, and if this is not the case, then the process 600 follows a NO arrow to a step 608. In the step 608, the user decides whether, notwithstanding the display of how the previously selected set of spectacle frames appears, whether they wish to select more spectacle frames for viewing. If this is not the case, then the process 600 follows a NO arrow to a STOP step 609.

Returning to the step 604, if it is desired to view more spectacle frames, then the process 600 follows a YES arrow back to the step 602. Returning to the step 607, if it is desired to replay the display, then the process 600 follows a YES arrow back to the step 606. Returning to the step 608, if it is, in fact, desired by the user to view even more sample spectacle frames, then the process 600 follows a YES arrow back to the step 602.

The display process 500 of FIG. 9 can operate in one of a number of different display modes.

In the SINGLE-IMAGE FIXED-DELAY mode, a single image 301 (see FIG. 4) of the user wearing the new spectacle frames is captured, and this single image is written by the step 404 in FIG. 8 to the memory 303 thereby loading the desired image. The steps 503-505 in FIG. 9 display this single still-image of the user when the user provides the appropriate user input 313 as depicted by the dashed line 507. The aforementioned image will only be displayed for a fixed time interval, after which a screen-saver or other default image will be displayed on the screen 103 (see FIG. 7). If the user wishes to again view the same still-image, this is achieved when the user activates the step 506 as depicted by the dashed arrow 508,

A MULTIPLE STILL-IMAGE mode provides the user with the option of looping through the steps 602-604 (see FIG. 10) multiple times by electing to try on more than one target spectacle frame before viewing the results comparatively. This process causes the step 404 in FIG. 8 to record the sequence of still-images associated with the corresponding series of sample spectacle frames tried on by the user. This multiple set of still-images is loaded, being recorded in the memory 303. In this mode, when the user actives the display process in the step 606 of FIG. 10, then the steps 503-505 in FIG. 9 either display the sequence of still-images in a mosaic-type display on the screen 203 (see FIG. 6), thereby displaying the entire sequence simultaneously in sub-image squares on the display, or alternately, the steps 503-505 display individual still-images of the sequence successively in a looping-fashion until each of the aforementioned still-images has been seen once.

A VIDEO mode captures a video clip when the user activates, as depicted by the dashed line 407, the memory write process 400 of FIG. 8. The length of the aforementioned video sequence can either be of fixed duration, or the user can select a desired length for the video clip by inputting suitable user input commands at 313 of FIG. 4. When the user activates the display process 500, as depicted by the dashed line 507, then the steps 503-505, according to one arrangement, replay the aforementioned video clip once for the user to see.

Alternately, activation of the step 404 in FIG. 8 can trigger a timer (not shown) that emits the activation signal 507 of FIG. 9. The effect of this arrangement is that once the user 801 has, for example, tried on a particular spectacle frame of interest, and has activated the memory write process 400 via the user input 407, then the display process 500 is automatically activated after a predetermined time. From a practical perspective, this means that the user is able to walk up to the arrangement 800 of FIG. 7, take off their own spectacles, put on a spectacle frame in which they are interested, take off the spectacle frame and put on their own spectacles, all this just in time to see a video clip of themselves on the screen 103 in which they wore the spectacle frames, turned around and so on in front of the camera 102. The VIDEO mode, when used with the aforementioned timer arrangement, effects an electronically delayed mirror that effectively displays what the electronically delayed mirror “saw” with a programmable time delay. In this manner the user can try on a pair of spectacle frames, take them off, put on their own prescription spectacle frames, and look at the electronically delayed mirror, just in time to see themselves wearing the spectacle frames they tried on. Similarly, the user can hold the electronically delayed mirror up to the back of their head, and bring the electronically delayed mirror into viewing position just in time to see how the back of their head looks.

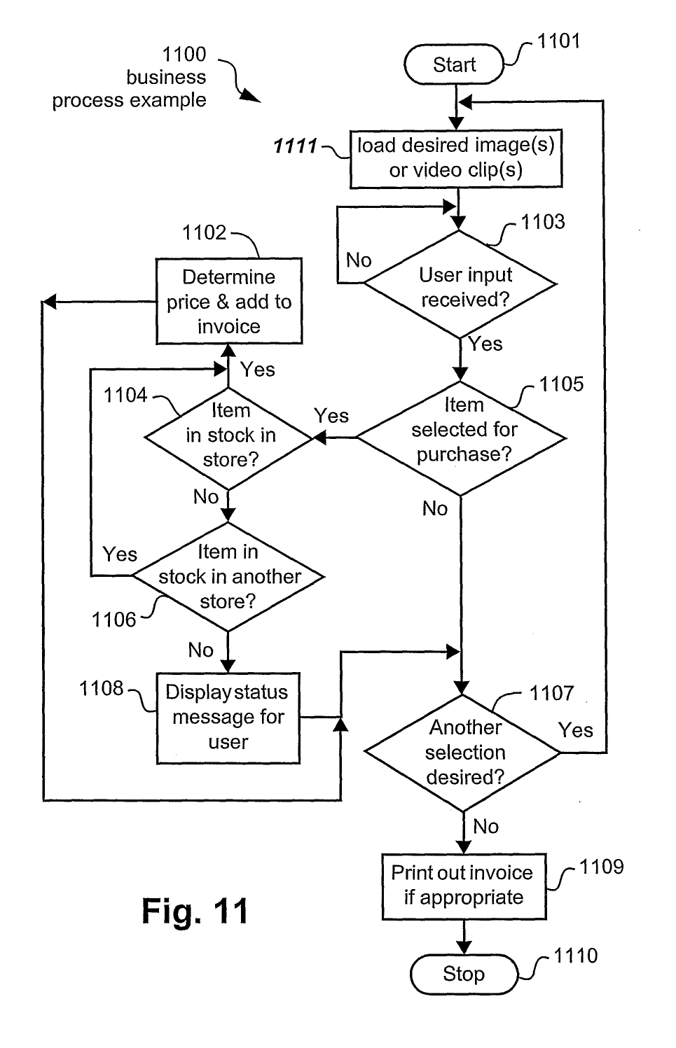

FIG. 11 depicts another business process flowchart using the electronically delayed mirror. The description is directed primarily to the hand-held arrangement of FIG. 3, however it applies generally to the desk-mounted arrangement of FIG. 2 as well.

The depicted process 1100 commences with a start step 1101 after which a step 1111 loads the desired image(s). These can be images that are captured currently by the user as depicted in FIG. 8 for example, or can be historical images that were previously captured and loaded into memory. This is described in relation to FIG. 12. A following decision step 1103 determines if the user has provided a command 313 via the user input controls 204 If this is not the case, then the process 1100 follows a NO arrow and loops back to the step 1103.

If the user has provided a control signal 313, then the process 1100 follows a YES arrow from the step 1103 to a step 1105. The step 1105 determines if the signal provided by the user is a command to purchase an item previously designated by the user. This designation would typically have been made by the user inputting an appropriate set of commands and information (such as a catalogue number etc.) via the user input controls 204. If this is the case, then the process 1100 follows a YES arrow to a step 1104. The step 1104 determines if the designated item is in stock in the store. This is done by the processor 307 interrogating a database containing stock levels and prices, this database typically being stored in a memory (not shown) of the remote processor 315.

If the selected item is in stock in the store, the process 1100 follows a YES arrow to a step 1102 which determines the appropriate price, and adds the price to an invoice intended to be given to the customer. The process 1100 also displays a message to this effect on the display 203 of the electronically delayed mirror 200.

The process 1100 is then directed from the step 1102 to a step 1107 which determines if the user wishes to select another item for possible purchase. Returning to the step 1104, if the selected item is not in stock in the store in question, then the process follows a NO arrow from the step 1104 to a step 1106. The step 1106 determines if the desired item is in stock in another store affiliated with the store in question. This involves the remote processor 315 communicating over the network 1020 with a processor in the affiliated store (not shown). If the item is in stock in the affiliated store, then the process follows a YES arrow from the step 1106 to the step 1102.

If the item is not in stock in the affiliated store, then the process 1100 follows a NO arrow from the step 1106 to a step 1108 which displays an appropriate message on the display 309 of the electronically delayed mirror 200. The process 1100 is then directed from the step 1108 to the step 1107.

Returning to the step 1105, if the user does not indicate that the designated item is to be purchased, then the process 1100 follows a NO arrow from the step 1105 to the step 1107. If the step 1107 determines that another item is to be viewed on, or loaded onto, the electronically delayed mirror 200 and considered form purchase, then the process 1100 follows a YES arrow from the step 1107 to the step 1111. If this is not the case, however, then the process 1100 follows a NO arrow from the step 1107 to a step 1109 which totals up the amount owed in regard to the purchases made, and prints out the invoice with the necessary information on the printer 311. The process 1100 then terminates with a stop step 1110.

The described process 1100 can be used in regard to purchase of items as diverse as spectacles, clothes, passport photographs, and so on.

FIG. 12 shows how the business process of FIG. 11 can be applied to current and historic stored image(s) having regard to the step 1111 in the process 1100 in FIG. 11. The process 1111 is preceded by the step 1101 in FIG. 11, after which the process 1111 is directed to a step 1201. The step 1201 determines if current images or historic images are to be considered on the electronically delayed mirror 200 (or the desk-mounted version 100). This situation would arise, for example, if the user came into an optometrist to try on spectacles last week, and tried on many pairs of spectacles but made no purchases. This week the user wishes to both see the previous pairs tried, and to try new ones.

If new images are desired, then the process 1111 follows a NEW arrow from the step 1201 to a step 1202 which loads new images according to the process 400 in FIG. 8 for example. The process 1111 is then directed to the step 1103 in FIG. 11. Returning to the step 1201, if historic images are desired, then the process 1111 follows a HISTORIC arrow from the step 1201 to a step 1203 which receives address information pointing to the memory location in the remote processor 315 where the images are stored. The aforementioned address can be provided by the user entering their account number, for example. Thereafter a step 1204 access the historic images, and the process 1111 is directed to the step 1103 in FIG. 11.

### INDUSTRIAL APPLICABILITY

It is apparent from the above that the arrangements described are applicable to the image processing industries.

The foregoing describes only some embodiments of the present invention, and modifications and/or changes can be made thereto without departing from the scope and spirit of the invention, the embodiments being illustrative and not restrictive.

Thus although the present description has been directed to use of the electronically delayed mirror for the purpose of purchasing spectacles, clearly other business processes such as trying on new clothes fall within the scope of the present electronically delayed mirror concept.

The disclosed method(s) for implementing the electronically delayed mirror comprise a particular control flow. There are many other variants of the preferred method(s) that use different control flows without departing the spirit or scope of the invention. Furthermore one or more of the steps of the preferred method(s) may be performed in parallel rather sequential.

1. An electronically delayed mirror apparatus for capturing and displaying at least one image of a subject in a delayed manner, the apparatus comprising:
an image detector;
a storage device for storing the at least one captured image;
a display for displaying the at least one captured image, wherein the display and the image detector are directed towards the subject of which the at least one image is to be captured; and
a time delay device for displaying the at least one captured image a specified time after the at least one image is captured.

2. An electronically delayed mirror apparatus for capturing a visual recording of a person, and displaying said recording in a manner offset in time from said capturing, the apparatus comprising:
an image detector;
a storage device for storing the visual recording;
a display for displaying the visual recording, wherein the display and the image detector are both directed towards the subject to be visually recorded; and
a time delay device for establishing the time offset.

3. An electronically delayed mirror according to claim 2, wherein the image detector, the storage device, the display and the time delay device are housed in a hand-held cosmetic mirror configuration.

4. An electronically delayed mirror according to claim 3, further comprising:
a processor; and
a software program for directing the processor to execute a method for capturing the visual recording of the person, and for displaying said recording in a manner offset in time from said capturing.

5. An electronically delayed mirror according to claim 4, further comprising:
a user interface enabling a user to provide at least one of:
a control input for establishing the nature of the time offset; and
information associated with an item to be purchased, said item forming an element in the visual recording.

6. An electronically delayed mirror according to claim 5, further comprising communication means for communicating at least one of the visual recording and the information to a processor.

7. An electronically delayed mirror according to claim 5, wherein the time offset is a pre-determined interval.

8. A system for display and sale of an item, the system comprising:
an electronically delayed mirror apparatus for capturing a visual recording of a person, and displaying said recording in a manner offset in time from said capturing, the apparatus comprising:
an image detector;
a storage device for storing the visual recording;
a display for displaying the visual recording, wherein the display and the image detector are both directed towards the subject to be visually recorded;
a time delay device for establishing the time offset;
a user interface enabling a user to provide information associated with the item to be purchased, said item forming an element in the visual recording; and
communication means for communicating the information to a processor;
the processor, being able to access a database storing stock level and pricing information for said merchandise; and
said database; wherein the system uses information provided by the user via the user interface and communicated to the processor to process information in the database in order to effect a transaction relating to said sale of said item.

9. A system according to claim 8 wherein the processor is remote from the electronically delayed mirror apparatus.

10. A method for capturing and displaying at least one image of a subject in a delayed manner, the method comprising the steps of:
simultaneously directing an image detector and a display towards the subject of which the at least one image is to be captured;
capturing the at least one image;
storing the at least one captured image; and
displaying the at least one captured image a pre-determined delay time after the at least one image is captured.

11. A method for capturing a visual recording of a person, and displaying said recording in a manner offset in time from said capturing, the method comprising the steps of:
directing an image detector and a display towards the person to be visually recorded;
capturing the visual recording;
storing the visual recording; and
displaying said recording in a manner offset in time from said capturing.

12. A method according to claim 11, wherein the offset is a predetermined time period less than the duration of the visual recording.

13. A method according to claim 10, wherein:
the at least one image captured is a video clip; and
the capturing and the displaying steps are continuously and concurrently performed, thereby providing, after the pre-determined delay, a continuous representation of the subject that is dependent upon an orientation with which the image detector and the display are directed towards the subject.

14. A method according to claim 10, wherein:
the at least one image comprises at least one still image; and
the displaying step displays each said at least one image with a correspondingly incremented pre-determined delay.

15. A method according to claim 10, wherein:
the at least one image comprises a plurality of still images; and
the displaying step displays said plurality of images simultaneously in a mosaic manner on the display, after a pre-determined delay.

16. A method of selling a pair of new spectacle frames to a purchaser who needs to use prescription lenses in other spectacle frames to assess suitability of the new spectacle frames, the method comprising the steps of:
capturing, using an apparatus according to claim 1, at least one image of the purchaser wearing the new spectacle frames; and
presenting, using said apparatus, the at least one image to the purchaser, wherein the predetermined delay is sufficient to enable the purchaser to replace the new spectacle frames with the other spectacle frames having the prescription lenses.

17. A method of selling a pair of new spectacle frames to a purchaser who needs to use prescription lenses in other spectacle frames to assess suitability of the new spectacle frames, the method comprising the steps of:
capturing, using an apparatus according to claim 1, a recorded video clip of the purchaser wearing the new spectacle frames; and
presenting, using said apparatus, the recorded video clip after a time delay, said delay being less than the duration of the video clip and sufficient to enable the purchaser to replace the new spectacle frames with the other spectacle frames having the prescription lenses.

18. A computer program product including a computer readable medium having recorded thereon a computer program for directing an apparatus according to claim 1 to execute a method for capturing and displaying at least one image of a subject in a delayed manner, the program comprising:
code for simultaneously directing an image detector and a display towards the subject of which the at least one image is to be captured;
code for capturing the at least one image;
code for storing the at least one captured image; and
code for displaying the at least one captured image a pre-determined delay time after the at least one image is captured.

19. A system for selling an item, the system comprising:
an apparatus according to claim 1 having communication means for communicating a user command to a computer;
said computer having a memory for storing a program and a processor for executing the program; and
a database, accessible by the computer, storing stock levels and prices associated with items for sale; said program comprising
code for detecting a purchase command from said apparatus;
code for determining at least one of cost and availability of the item designated by the purchase command; and
code for effecting at least part of a transaction purchasing the designated item dependent upon said at least one of cost and availability.

20. An electronically delayed mirror apparatus for capturing a visual recording of a person, and displaying said recording in a manner offset in time from said capturing, while said capturing continues, the apparatus comprising:
an image detector;
a storage device for storing the visual recording;
a display for displaying the visual recording, wherein the display and the image detector are both directed towards the subject to be visually recorded; and
a time delay device for establishing the time offset.

21. An electronically delayed mirror apparatus for capturing a visual recording of a person, and displaying said recording in a manner offset in time from said capturing, while said capturing continues, the apparatus comprising:
a memory for storing a program; and
a processor for executing the program, said program comprising:
code for effecting the visual recording of the person captured by the image detector;
code for storing said visual recording; and
code for displaying the visual recording in a manner offset in time from said capturing, while said capturing continues.
